(19) United States
(12) Patent Application Publication
(10) Pub. No.: US 2009/0257174 A1
(43) Pub. Date: Oct. 15, 2009

(54) SELF-DISENGAGING CONTACTS FOR SECONDARY CIRCUITS OF DRAW-OUT TYPE CIRCUIT BREAKERS

(76) Inventors: Mahesh Jaywant Rane, Secunderabad (IN); Simhadri Ramalingeswara Gupta, Andra Pradesh (IN); Janakiraman Narayanan, Andra Pradesh (IN)

Correspondence Address: General Electric Company;GE Global Patent Operation, PO Box 861, 2 Corporate Drive, Suite 648, Shelton, CT, 06484, US

(21) Appl. No.: 12/103,194

(22) Filed: Apr. 15, 2008

(51) Int. Cl. H02B 1/04

(52) U.S. Cl. 361/673

(57) ABSTRACT

A circuit breaker is provided and includes a cassette, including a housing surface, a cassette-side terminal block attached to the cassette, including terminal housings arrayed thereon, being rotatable about the housing surface, a circuit breaker configured to be removably inserted into the cassette during a rack-in operation, and a circuit breaker-side terminal block attached to the circuit breaker with terminal housings arrayed thereon.

### BACKGROUND OF THE INVENTION

Aspects of the present disclosure are directed to draw-out type circuit breakers and, more particularly, to draw-out type circuit breakers in which a secondary disconnect terminal block is rotatable.

### BRIEF DESCRIPTION OF THE BACKGROUND

Circuit breakers are capable of interrupting high ampere current in various industrial, commercial or personal electrical applications and may be categorized generally as draw-out types of circuit breakers and fixed types of circuit breakers. In that capacity, both types of circuit breakers may be attached to circuitry and, in particular, to a switchboard with limited spatial capacity. As such, it is desirable to construct both types of circuit breakers with increasingly smaller and smaller components without sacrificing accessibility.

In conventional draw-out types of circuit breakers, compact size has been accomplished by forming a cassette to be attached to the main power circuitry, and a circuit breaker that is drawn into and out from the cassette. For secondary control circuits, the cassette is provided with a fixed secondary terminal block that cooperates with a fixed secondary terminal block of the circuit breaker to form appropriate electrical connections for the secondary control circuits of the circuit breaker. However, given the above-noted spatial limitations and since the terminal block of the cassette is fixed relative to the cassette in the conventional circuit breakers, it may be difficult or impossible for an operator to conduct wiring processes of the terminal block of the cassette in a completed installation.

### SUMMARY OF THE INVENTION

In accordance with an aspect of the invention, a circuit breaker apparatus is provided and includes a cassette, including a housing surface, a cassette-side terminal block rotatably attached to the housing surface of the cassette, including first terminal housings arrayed thereon, and being rotatable between at least a first position and a second position, a circuit breaker configured to be removably inserted into the cassette during a rack-in operation, and a circuit breaker-side terminal block attached to the circuit breaker with second terminal housings arrayed thereon to positionally cooperate with the first terminal housings when the cassette-side terminal block is in the first position and when the rack-in operation is at least partially complete.

In accordance with another aspect of the invention, a circuit breaker apparatus is provided and includes a cassette having an external structure, including a housing surface, a cassette-side terminal block attached to the housing surface via a hinge about which the cassette-side terminal block rotates between at least a service position thereof and a wiring position thereof, a set of female terminal housings arrayed on the cassette-side terminal block, a circuit breaker configured to be removably inserted into a connected position with the cassette during a rack-in operation, a circuit breaker-side terminal block attached to the circuit breaker, and a set of male terminal housings arrayed on the circuit breaker-side terminal block to positionally cooperate with the female terminal housings when the cassette-side terminal block is in the service position and when the rack-in operation is at least partially complete.

In accordance with another aspect of the invention, a circuit breaker apparatus is provided and includes a cassette having an external structure, including a housing surface, a cassette-side terminal block attached to the housing surface via a hinge about which the cassette-side terminal block rotates between at least a service position thereof and a wiring position thereof, a set of female terminal housings arrayed on the cassette-side terminal block, a circuit breaker configured to be removably inserted from a disconnected position and into at least a test position and a connected position with the cassette during a rack-in operation, a circuit breaker-side terminal block attached to the circuit breaker, and a set of male terminal housings arrayed on the circuit breaker-side terminal block to positionally cooperate with the female terminal housings when the cassette-side terminal block is in the service position and when the rack-in operation is at least in the test position and/or the connected position.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTIONS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIGS. 1A and 1B are perspective views of a draw-out type of circuit breaker in accordance with an embodiment of the invention; and

FIGS. 2A and 2B are perspective views of a cassette and a cassette-side terminal block of the circuit breaker of FIGS. 1A and 1B;

FIGS. 3A and 3B are enlarged views of the cassette-side terminal block of FIGS. 2A and 2B;

FIGS. 4A and 4B are perspective views of a draw-out type of circuit breaker in accordance with a second embodiment of the invention;

FIGS. 5A and 5B are perspective views of male and female terminal housings in accordance with an embodiment of the invention;

FIG. 6 is a side sectional view of a cooperative engagement between the male and female terminal housings of FIGS. 5A and 5B;

FIG. 7 is a side sectional view of a circuit breaker-side terminal block of the circuit breaker of FIGS. 1A and 1B;

FIG. 8 is a perspective view of a circuit breaker-side terminal block of the circuit breaker of FIGS. 1A and 1B; and

FIGS. 9A and 9B are views of alignment and locking features in accordance with embodiments of the present invention.

### DETAILED DESCRIPTION OF THE INVENTION

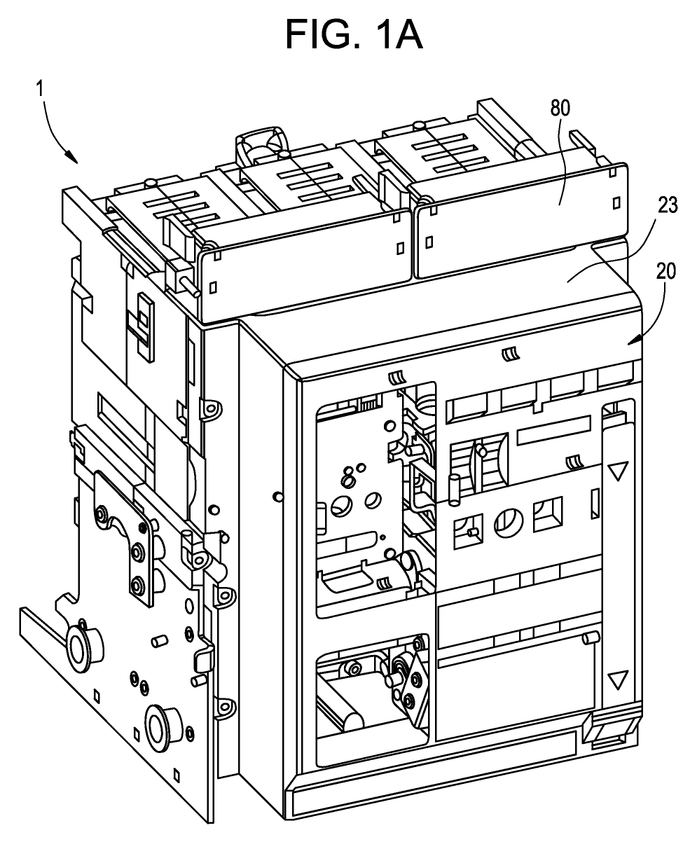

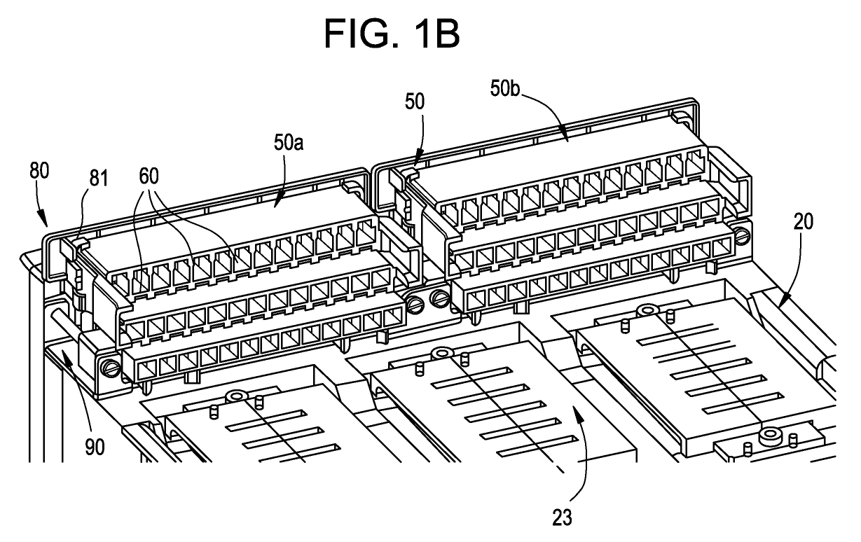

With reference to FIGS. 1A, 1B, 2A, 2B, 3A and 3B, a draw-out type of a circuit breaker apparatus 1 is provided. The circuit breaker apparatus 1 includes a cassette 11 that is attachable to a switchboard (not shown) and a circuit breaker 20, which is removably inserted into the cassette 11 during a rack-in operation thereof that may be conducted by an operator or a user. The cassette 11 has an external structure that includes at least four housing surfaces 12, 13, 14 and 15 as well as a rear surface 16. The housing surfaces are arranged together to form an interior region into which the circuit breaker 20 is removably inserted. A cassette-side terminal block 30 is attached to one of the housing surfaces, for example, housing surface 13, via a set of pivot bosses 31 that extends along rotational axis 32. The cassette-side terminal block 30 is therefore configured to rotate about the rotational axis 32 between at least a first (that is, a service) position 33 and a second (that is, a wiring) position 34.

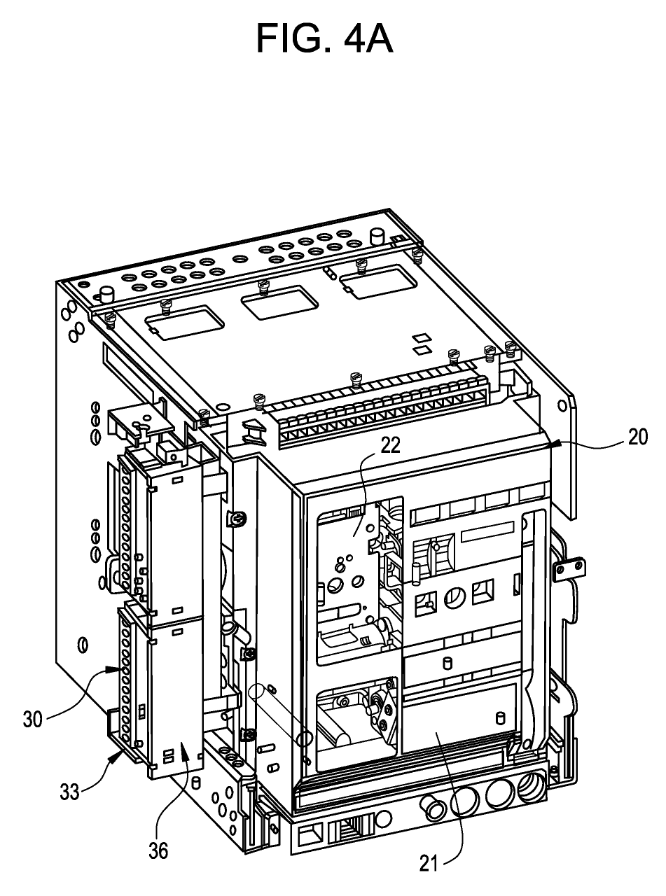

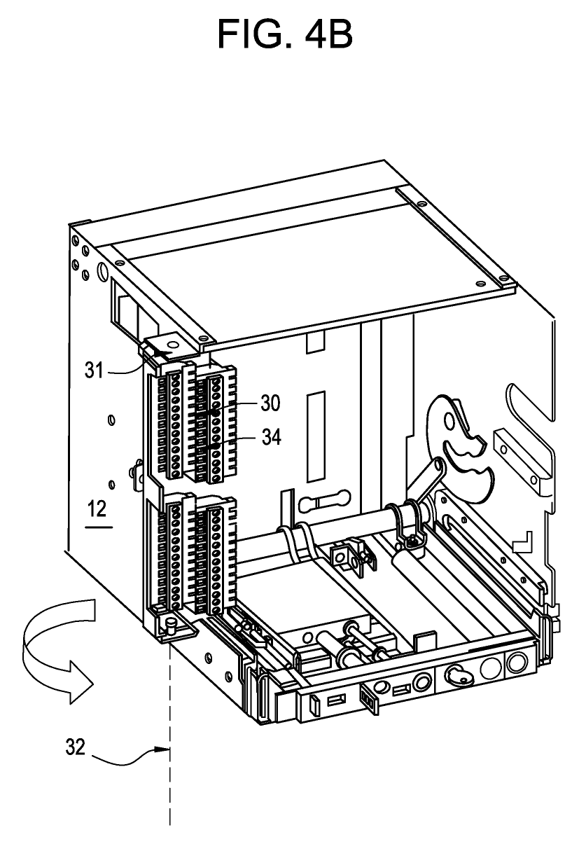

Here, while housing surface 13 is the top surface of the cassette 11, it is understood that embodiments of the invention exist in which the cassette-side terminal block 30 is attached to other housing surfaces, for example, housing surfaces 12 or 14, in a similar manner as described above. For example, as shown in FIGS. 4A and 4B, the cassette-side terminal block 30 may be attached to housing surface 12.

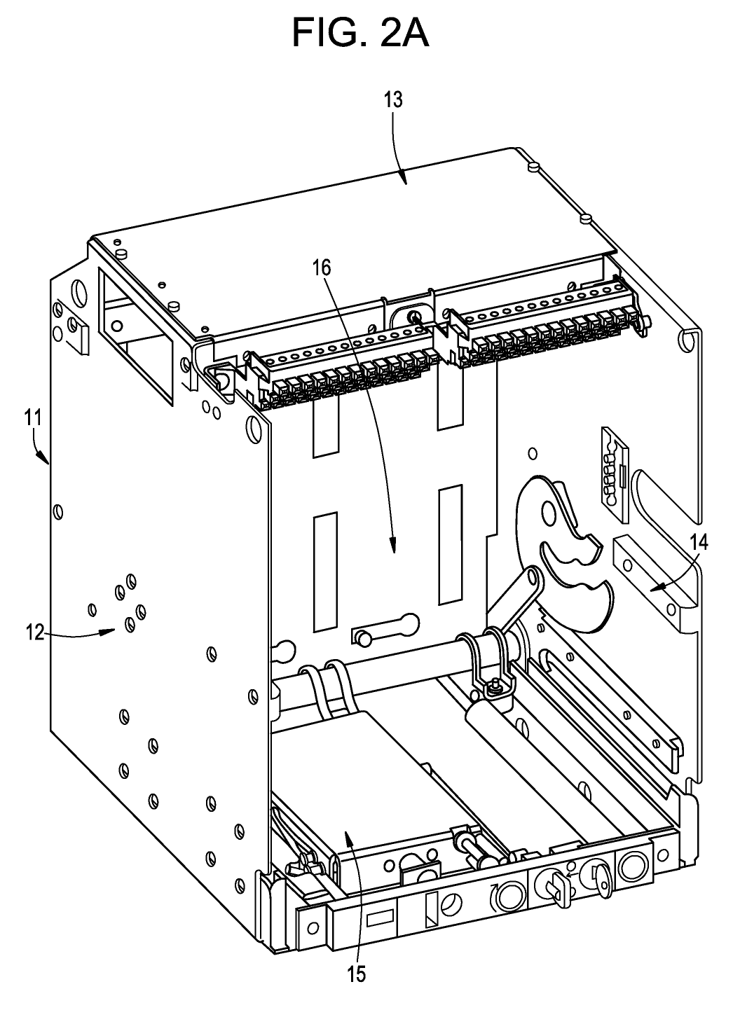

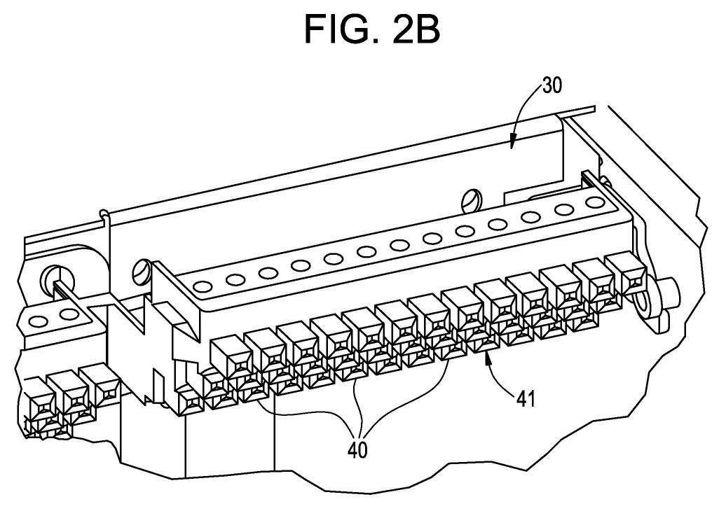

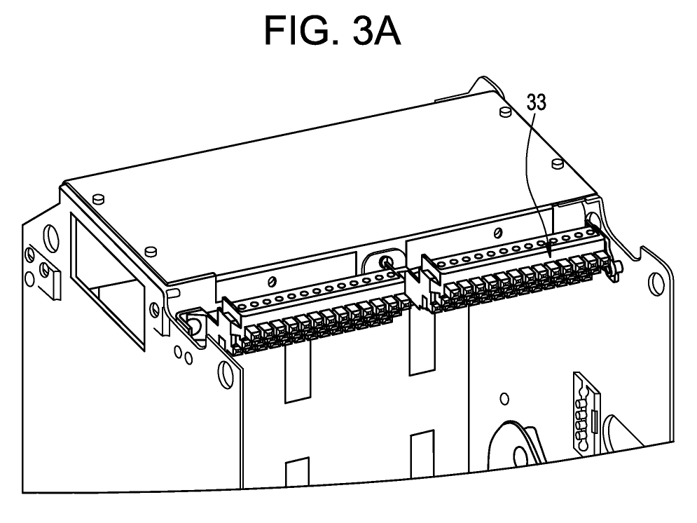

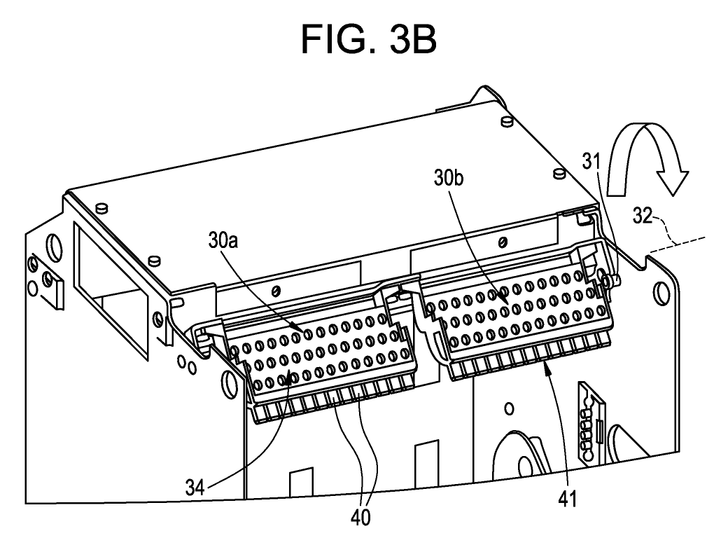

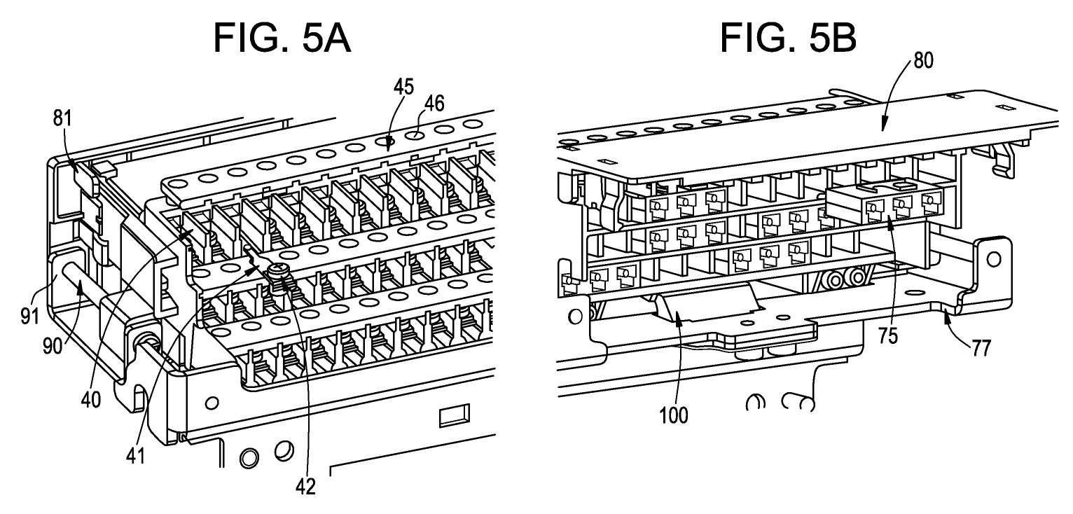

With reference still to FIGS. 2A, 2B, 3A and 3B and with additional reference to FIGS. 5A and 5B, a set of female terminal housings 40 is arrayed on the cassette-side terminal block 30. Each of the female terminal housings 40 may be integrally connected to the cassette-side terminal block 30 and may support female terminals 41 therein. A protection covering 45 is provided for each of the female terminal housings 40. Here, in an embodiment of the invention, the protection covering 45 may include, for example, removable IP20 protection covers or any other suitable protection covers.

Each of the female terminal housings 40 may include a screw type terminal having a terminal screw 42 that may be driven by the operator during wiring processes with the circuit breaker 20 at an external position of a disconnected position. These wiring processes may be carried out by the operator at a front of the cassette 11 and by way of the cassette-side terminal block 30 being rotated with respect to the housing surface to which it is attached into the wiring position 34 at which each terminal screw 42 is accessible. To this end, the protection covering 45 may include through holes 46 defined therein to provide the operator with access to corresponding terminal screws 42.

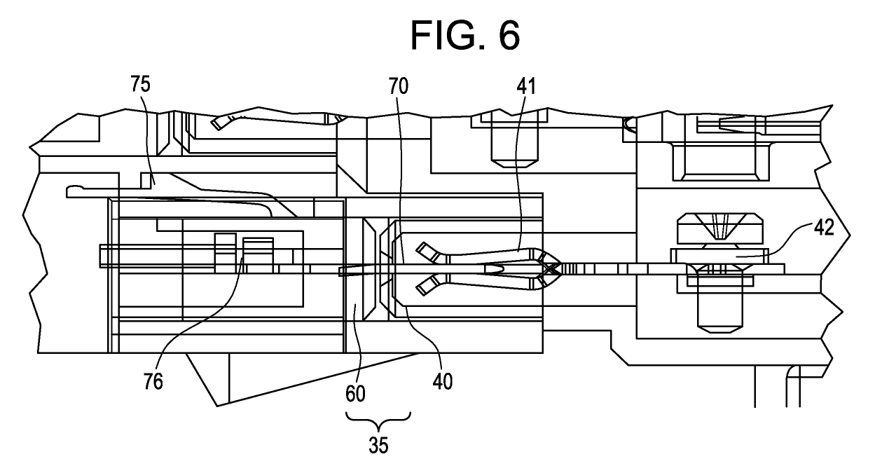

With reference back to FIGS. 1A, 1B, 4A and 6, the circuit breaker 20 may be removably inserted from the disconnected position and into at least a test position 35 (see FIG. 6) and then a connected position 36 (see FIG. 4A) of the rack-in operation. As shown, the circuit breaker 20 has an exterior shape that generally corresponds with that of the interior region of the cassette 11 and a front surface 21 that allows for operator access to its interior components 22.

A circuit breaker-side terminal block 50 is attached to a surface 23 of the circuit breaker 20. A set of male terminal housings 60 is arrayed on the circuit breaker-side terminal block 50. The set of male terminal housings 60 is positioned by the circuit breaker-side terminal block 50 to positionally cooperate with the female terminal housings 40. In particular, the set of male terminal housings 60 positionally cooperates with the female terminal housings 40 when the cassette-side terminal block 30 is in the service position 33 and when the rack-in operation has been completed to, at least, the test position 35 and/or the connected position 36. Further, the set of male terminals 60 is positionally non-cooperative with the female terminal housings 40 when the cassette-side terminal block 30 is in the wiring position 34.

With reference to FIGS. 1A and 1B and 5A and 5B, in accordance with an embodiment of the invention, the circuit breaker 20 may further include a cover 80. The cover 80 is configured to cover a front portion of the circuit breaker-side terminal block 50 and is attached via a hinge 81 to either the circuit breaker 20 or the circuit breaker-side terminal block 50. In this way, the cover 80 is rotatable about the hinge 81 so as to allow for front-side access to the circuit breaker-side terminal block 50.

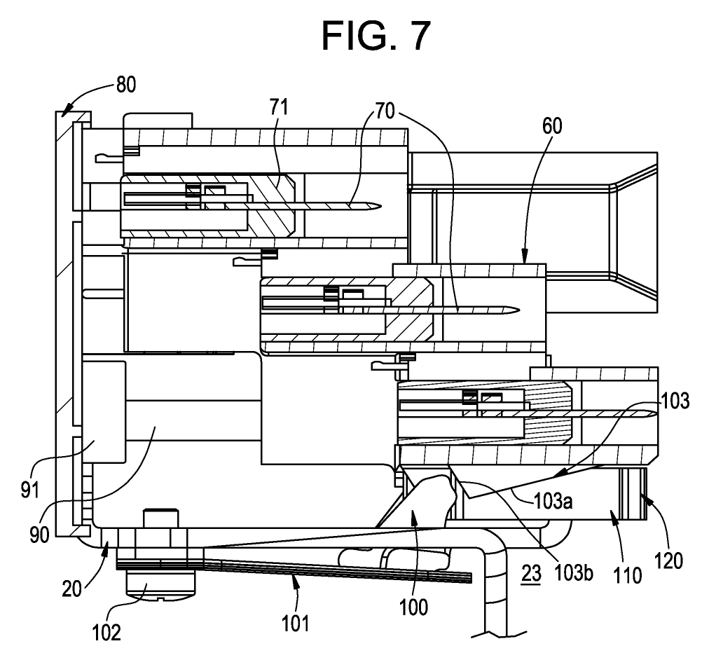

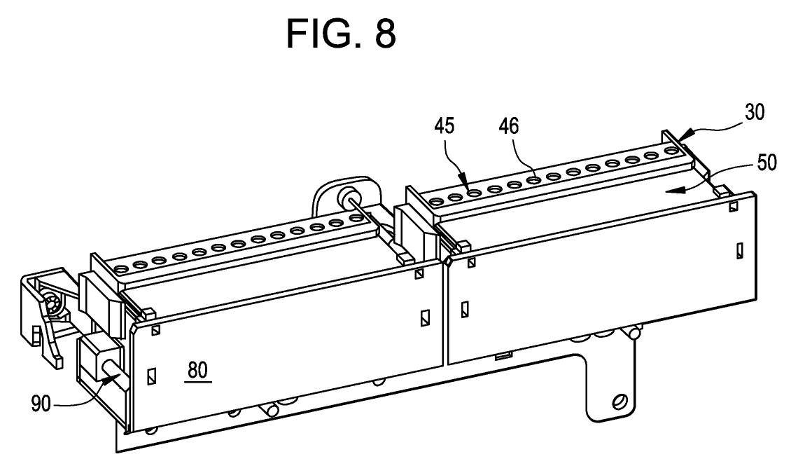

Still referring to FIGS. 5A and 5B and with additional reference to FIGS. 7 and 8, it is noted that the male terminal housings 60 are configured to accept a set of male terminals 70, which may be supported by connectors 71. Here, it is understood that the male terminals 70 may be previously installed within the male terminal housings 60 or they may be jointly or individually installed as needed at any time. For example, in an embodiment of the invention, as shown in FIGS. 5B and 6, a set of the male terminals 70 may be configured as an accessory plug 75. Here, the accessory plug 75 is received within the male terminal housings 60 in a snap-in configuration with the accessory plug cable 76 crimped to the male terminal 70. The accessory plug cable 76 may then be drawn from the male terminal housings 60 between the circuit breaker-side terminal block 50 and the cover 80 and then through the aperture 77.

With reference to FIGS. 5A and 7, the circuit breaker 20 includes a guide pin 90, along which the circuit breaker-side terminal block 50 slides during the rack-in operation, and a cam 100 to support the circuit breaker-side terminal block 50 during the rack-in operation. The guide pin 90 is integrally connected to a first structural support 91 of the circuit breaker 20 and extends substantially in parallel with the movement direction of the circuit breaker 20 during the rack-in operation. The cam 100 is supported at distal ends of springs 101, which are connected to a second structural support 102 of the circuit breaker 20. The cam 100 is biased by the springs 101 into cooperative engagement with both a rear edge 103a and a forward edge 103b of ramp 103, which is connected to an underside of the circuit breaker-side terminal block 50, in accordance with a current stage of the rack-in operation.

With reference to FIGS. 1A, 1B and 6, during the rack-in operation, as noted above, the circuit breaker 20 first moves from the disconnected position and into the test position 35. Here, at least the female terminal housings 40 are brought into contact with at least the male terminal housings 60. From this position, as the circuit breaker 20 slides further into the cassette 11, the circuit breaker-side terminal block 50 slides along the guide pin 90 and is biased to remain aligned with the guide pin 90 by the cooperative engagement of the cam 100 with the rear edge 103a of the ramp 103 until the circuit breaker 20 reaches the connected position 36. At this point, the cam 100 is biased into a terminal block locking position, which may occur just prior to the circuit breaker 20 reaching the connected position 36, by the cooperative engagement of the cam 100 with the forward edge 103b of the ramp 103.

In accordance with an embodiment of the invention, in order to facilitate the removable insertion of the circuit breaker 20 into the cassette 11, the cassette-side terminal block 30 may be removable from the cassette 11 and the female terminal housings 40 may be configured to float relative to the housing surface 13. The removal of the cassette-side terminal block 30 is accomplished by removing a terminal block screw (not shown) and then lifting the cassette-side terminal block 30 from the pivot bosses 31. The floating of the female terminal housings 40 is accomplished by connecting a block of female terminal housings 40 to a bracket of the cassette-side terminal block 30 having a slot defined therein, into which a projection of the cassette-side terminal block 30 extends, with stepped screws. In this manner, the stepped screws tighten the cassette-side terminal block 30 to the bracket with the projection cooperating with the slot to guide the floating of the block of the female terminal housings 40.

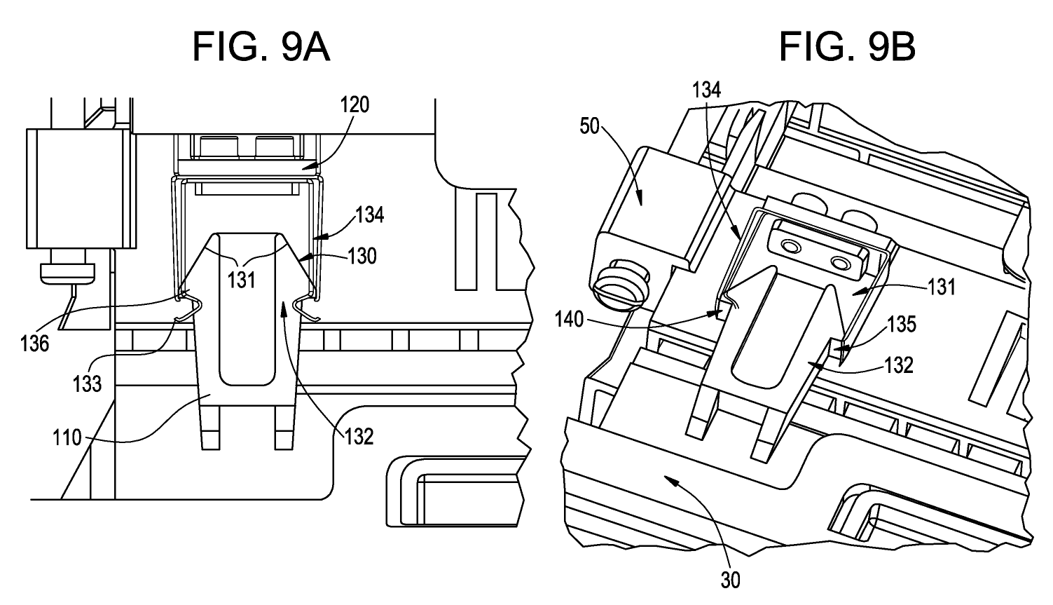

With reference to FIGS. 9A and 9B, when the circuit breaker 20 reaches the connected position, biased locking elements 110 and 120 of the circuit breaker-side terminal block 50 and the cassette-side terminal block 30 cooperatively engage with one another. Here, the biased locking elements 110 and 120 lock the circuit breaker-side terminal block 50 and the cassette-side terminal block 30 together to form a secondary disconnect.

In an embodiment of the invention, each of the biased locking elements 110 and 120 may respectively include alignment members 130 that are configured to cooperate during the rack-in operation and locking members 140 that are configured to cooperate once the circuit breaker 20 reaches the connected position 36. Here, both the alignment members 130 and the locking members 140 may be spring loaded. That is, the alignment members 130 may include relatively steeply angled surfaces 131 of plastic extensions 132 attached to the cassette-side terminal block 30 and relatively steeply angled surfaces 133 of elastic extensions 134 attached to the circuit breaker-side terminal block 50. Similarly, the locking members 140 may include relatively shallow angled surfaces 135 of the plastic extensions 132 and relatively shallow angled surfaces 136 of elastic extensions 134.

In accordance with various aspects of the present invention, a number of male and female terminals that could be used by a circuit breaker may be increased beyond what is presently possible given spatial limitations. That is, the cassette-side terminal block 30 and the circuit breaker-side terminal block 50 may each include 2 separate blocks 30a, 30b, 50a and 50b. Here, each separate block 30a, 30b, 50a and 50b may additionally include 3 rows of 13 columns of female and male terminal housings 40 and 60.

Although the embodiments described above are partly characterized by the female terminal housings 40 and the male terminal housings 60 being arrayed on the cassette-side terminal block 30 and the circuit breaker-side terminal block 50, respectively, it is understood that this position could be partly or entirely reversed. Where it is partly reversed, the respective terminal blocks could each support both male and female terminal housings in various combinations and patterns.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

We claim:

1. A circuit breaker apparatus, comprising:
a cassette, including a housing surface;
a cassette-side terminal block rotatably attached to the housing surface of the cassette, including first terminal housings arrayed thereon, and being rotatable between at least a first position and a second position;
a circuit breaker configured to be removably inserted into the cassette during a rack-in operation; and
a circuit breaker-side terminal block attached to the circuit breaker with second terminal housings arrayed thereon to positionally cooperate with the first terminal housings when the cassette-side terminal block is in the first position and when the rack-in operation is at least partially complete.

2. The circuit breaker apparatus according to claim 1, wherein the housing surface of the cassette is a top housing surface thereof.

3. The circuit breaker apparatus according to claim 1, wherein the housing surface of the cassette is a side housing surface thereof.

4. The circuit breaker apparatus according to claim 1, wherein the first and second terminal housings are female and male terminal housings, respectively.

5. The circuit breaker apparatus according to claim 4, wherein the first and second positions are a service position and a wiring position, respectively.

6. The circuit breaker apparatus according to claim 5, wherein each of the female terminal housings support female terminals therein.

7. The circuit breaker apparatus according to claim 5, further comprising a protection covering for each of the female terminal housings.

8. The circuit breaker apparatus according to claim 5, wherein each of the female terminal housings comprises a screw type terminal that is front-side accessible with the cassette-side terminal block in the wiring position.

9. The circuit breaker apparatus according to claim 1, wherein the cassette-side terminal block is configured to float relative to the housing surface.

10. The circuit breaker apparatus according to claim 1, wherein the cassette-side terminal block and the circuit breaker-side terminal block each comprise alignment members that are configured to cooperate during the rack-in operation.

11. The circuit breaker apparatus according to claim 1, the cassette-side terminal block and the circuit breaker-side terminal block each comprise biased locking elements that are configured to cooperate during the rack-in operation.

12. The circuit breaker apparatus according to claim 5, wherein the male terminal housings are configured to accept a set of male terminals therein.

13. The circuit breaker apparatus according to claim 12, wherein at least one of the male terminals is configured as an accessory plug.

14. The circuit breaker apparatus according to claim 5, wherein the male terminal housings are configured to receive an accessory plug in a snap-in configuration.

15. The circuit breaker apparatus according to claim 1, wherein the circuit breaker comprises a guide pin along which the circuit breaker-side terminal block slides during the rack-in operation.

16. The circuit breaker apparatus according to claim 15, wherein the circuit breaker further comprises a cam to support the circuit breaker-side terminal block during the rack-in operation.

17. The circuit breaker apparatus according to claim 1, wherein the circuit breaker comprises a rotatable cover configured to cover a front-side portion of the circuit breaker-side terminal block.

18. The circuit breaker apparatus according to claim 1, wherein the second terminal housings are positionally non-cooperative with the first terminal housings when the cassette-side terminal block is in the second position.

19. A circuit breaker apparatus, comprising:
a cassette having an external structure, including a housing surface;
a cassette-side terminal block attached to the housing surface via a hinge about which the cassette-side terminal block rotates between at least a service position thereof and a wiring position thereof;
a set of female terminal housings arrayed on the cassette-side terminal block;
a circuit breaker configured to be removably inserted into a connected position with the cassette during a rack-in operation;
a circuit breaker-side terminal block attached to the circuit breaker; and
a set of male terminal housings arrayed on the circuit breaker-side terminal block to positionally cooperate with the female terminal housings when the cassette-side terminal block is in the service position and when the rack-in operation is at least partially complete.

20. A circuit breaker apparatus, comprising:
a cassette having an external structure, including a housing surface;
a cassette-side terminal block attached to the housing surface via a hinge about which the cassette-side terminal block rotates between at least a service position thereof and a wiring position thereof;
a set of female terminal housings arrayed on the cassette-side terminal block;
a circuit breaker configured to be removably inserted from a disconnected position and into at least a test position and a connected position with the cassette during a rack-in operation;
a circuit breaker-side terminal block attached to the circuit breaker; and
a set of male terminal housings arrayed on the circuit breaker-side terminal block to positionally cooperate with the female terminal housings when the cassette-side terminal block is in the service position and when the rack-in operation is at least in the test position and/or the connected position.
